(19) United States
(12) Patent Application Publication
(10) Pub. No.: US 2026/0059619 A1
(43) Pub. Date: Feb. 26, 2026

(54) MAGNETIC INDUCTION FURNACE WITH IMPROVED HEATING EFFICIENCY

(71) Applicant: PRESEZZI EXTRUSION S.P.A., Vimercate (IT)

(72) Inventors: Mario BONIFACIO, Belgirate (IT); Valerio PRESEZZI, Lugano (CH)

(21) Appl. No.: 19/103,410

(22) PCT Filed: Aug. 28, 2023
(86) PCT No.: PCT/IB2023/058471

§ 371 Date: Feb. 12, 2025

(30) Foreign Application Priority Data
Aug. 30, 2022 (IT) 102022000017790

(51) Int. Cl. H05B 6/22; H02K 1/27; H02K 9/19

(52) U.S. Cl. CPC H05B 6/22; H02K 1/27; H02K 9/19

(57) ABSTRACT

A magnetic induction furnace configured to heat solid or tubular metal billets, of various lengths and diameters, made of non-ferrous materials. The furnace includes a fixed body in which there is arranged an electric motor having an annular rotor rotatably disposed in a stator. The annular rotor is joined to a rotor body carrying a plurality of permanent magnets arranged so as to define a hollow magnetic cylinder
having a cavity configured to contain a non-rotating billet to be heated. The permanent magnets of the rotor body comprise main permanent magnets magnetized in the radial direction with respect to such rotor body and auxiliary permanent magnets magnetized in the axial direction. The permanent magnets generate flux lines of a magnetic field directed inwardly, towards an interior of the cavity configured to contain the billet so as to improve the heating thereof.

Forming an object of the present invention is a magnetic induction furnace adapted to heat at least one solid or tubular metal billet, of various lengths and diameters made of non-ferrous materials, for example to be extruded, according to the preamble of the main claim. Such preamble is reported in KR 2019 0006782.

A such magnetic induction furnace exploits the known physical principle according to which by introducing a ferromagnetic or paramagnetic or diamagnetic or a conductor metal body into a magnetic field, in such body there are generated parasitic currents which lead to the heating of the metal body due to the Joule effect.

This physical principle is used for heating metal billets with the aim of making them more pliable and therefore more malleable for example for a subsequent extrusion operation, or a subsequent step of a thermal treatment process.

Various solutions which exploit such physical principle are known. For example, WO2010/100082 discloses a device or furnace for heating metal objects or billets through electromagnetic induction comprising an electric stator adapted to move at least one rotor inside permanent magnets of the ring type and into which there is positioned said object, for example cylindrical-shaped. Such rotor generates a parasitic current in the metal object so as to heat it so as to obtain a desired distribution or temperature profile along the longitudinal axis thereof. This, so as to differentiate the heating of said object or billet so as to have a subsequent uniform extrusion thereof.

However, in WO2010/100082, each billet or metal object is subjected to movement during the heating thereof, said movement possibly rotating around the axis thereof and/or longitudinal along such axis. This with the aim of obtaining uniform temperature distribution along the aforementioned axis, between the ends of the billet. This necessarily requires having means suitable to rotate and/or generate such axial movement of the billet, this complicating the manufacturing of the furnace and increasing the costs thereof.

In addition, in the support structure of the billet there may be vibrations due to the manufacturing tolerances of the billet which determine the need to create means adapted to absorb such vibrations with ensuing greater complexity of the structure.

In addition, the axial movement of the billet into and out of the furnace or—in any case—with the possibility of projecting therefrom during the displacement entails a continuous heating and subsequent cooling of the end of the billet (with considerable waste of energy), while the central part—always submerged in the variable or rotary magnetic field of the furnace—has temperatures that are high or greater than those of the ends. This negatively affects the extrusion operation to which the billet is subsequently subjected such that it cannot be used for such operation.

In addition, the means movably supporting the billet during the movement are also subjected to heating that could damage them over time.

Another known solution is described in US2010/147833. This prior art document provides for an apparatus for heating a billet or workpiece being processed by magnetic induction. It provides for the presence of a first annular magnetic unit, rotating around the billet or workpiece being processed, inserted (coaxially) into a second annular magnetic unit. The first magnetic unit is contained in a concentric (thermal) insulation element given that the first magnetic unit uses iron cores around which there are provided for windings of high temperature super conductors or HTSC which have a transition temperature above 77K (that is approximately −196° C.).

This solution entails the need to cool the first magnetic unit, proximal to the workpiece to be heated, and this operation is very difficult both because such unit is inside the heating apparatus (and therefore difficult to achieve) and because such unit is proximal to an element being heated.

In addition, the HTSC windings must however be power-supplied or energised and this operation is difficult to carry out in the light of the position of the first magnetic unit inside the apparatus.

Furthermore, specifically due to the use of HTSC, the cavity in which they are arranged (defined by the insulation elements) is subjected to vacuum and this entails very high implementation difficulties.

Generally, the known solution entails a low efficiency in the light of the need to cool the HTSC windings and generate the vacuum for the insulation thereof.

Besides the above there should also be observed the fact that, in the prior art apparatus, the workpiece to be heated is movable with respect to the apparatus and—in any case—it is not entirely contained in the latter (and it should therefore be movable): therefore, the heating of the aforementioned workpiece occurs by sections, but it cannot be obtained and subjected to maintenance operations evenly; this given that, when a part of such workpiece heats, another part (outside the apparatus) cools.

This also reduces the efficiency of the prior art solution.

US2010/147834 also discloses the use of windings which can be a superconductor (with the same disadvantages described above relating to US2010/147833) and which should in any case be power-supplied to create the magnetic field useful for heating the billet being processed.

Therefore, also in this case, there is a significant energy consumption used for heating the billet mostly due to the need to cool the superconductor windings and always keep them at very low temperatures in order to maintain the superconductor effect.

In addition, US2010/147834 discloses that the workpiece to be heated or billet rotates, and this could also cause a deformation of the ends of the billet supported by gripping members, and which can negatively affect the subsequent extrusion operation.

An object of the present invention is to provide a magnetic induction furnace for heating solid or tubular metal billets measuring any length, cross-section or diameter, made of non-ferrous materials (such as for example aluminium and aluminium alloys) for example to be subjected to extrusion or to subsequent thermal treatments, which is improved with respect to the prior art furnaces and which has an improved efficiency with respect to prior art furnaces.

In particular, an object of the invention is to provide a furnace of the type mentioned above which allows to have a magnetic flux which impacts a billet arranged therein having penetration capacity that is greater than the one found in similar prior art furnaces.

Another object is to provide a furnace in which the billet can be heated at the desired temperature evenly over the entire length thereof and cross-section, reducing thermal dissipations to the minimum.

A further object is to provide a furnace of the type mentioned above in which the magnetic flux which can exit towards the external thereof is smaller with respect to similar prior art furnaces.

These and other objects which shall be more apparent to the man skilled in the art are attained by furnace according to the main claim.

For a better understanding of the present invention, the following drawings are attached hereto, purely by way of non-limiting example, wherein:

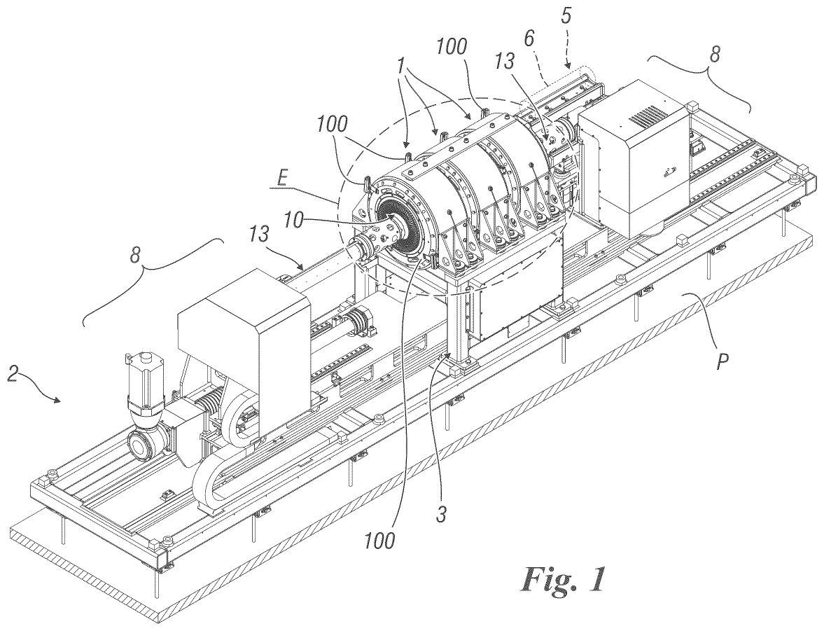

FIG. 1 shows a perspective view of a system for heating metal billets which uses furnaces with magnetic sections according to the invention, arranged consecutively and with horizontal longitudinal axes with respect to a support a support of the system;

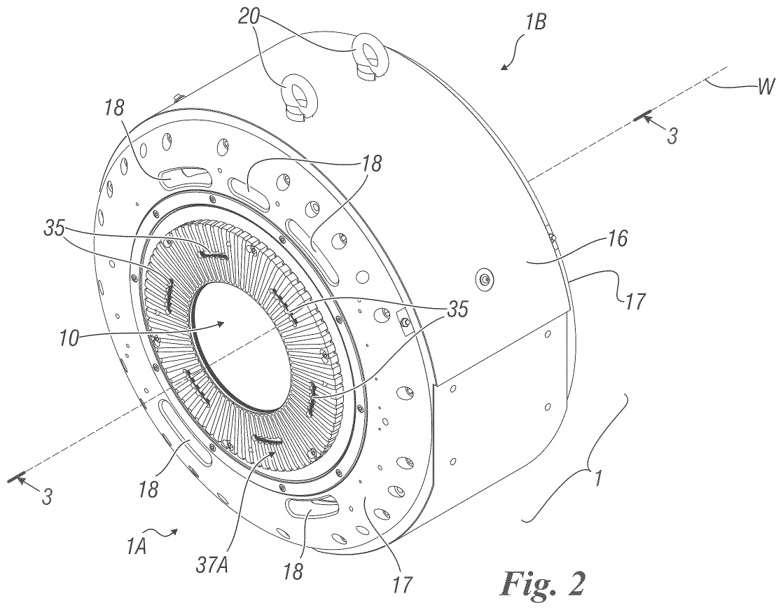

FIG. 2 shows a perspective view of magnetic induction furnace according to the invention;

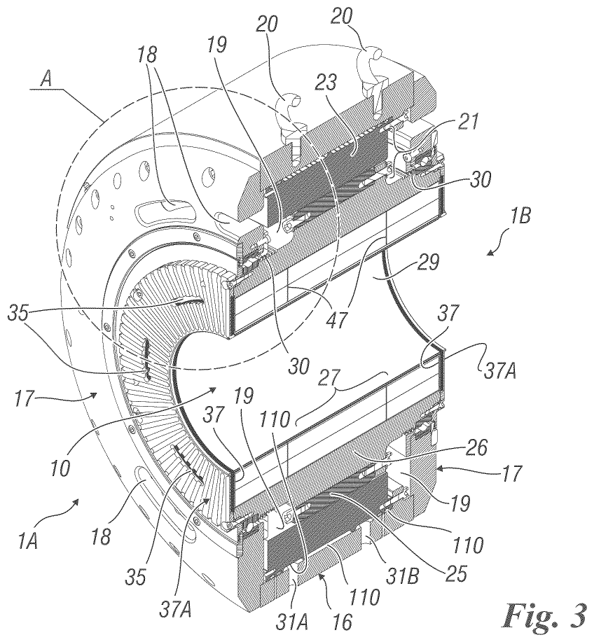

FIG. 3 shows a cross-sectional view according to line 3-3 of FIG. 2;

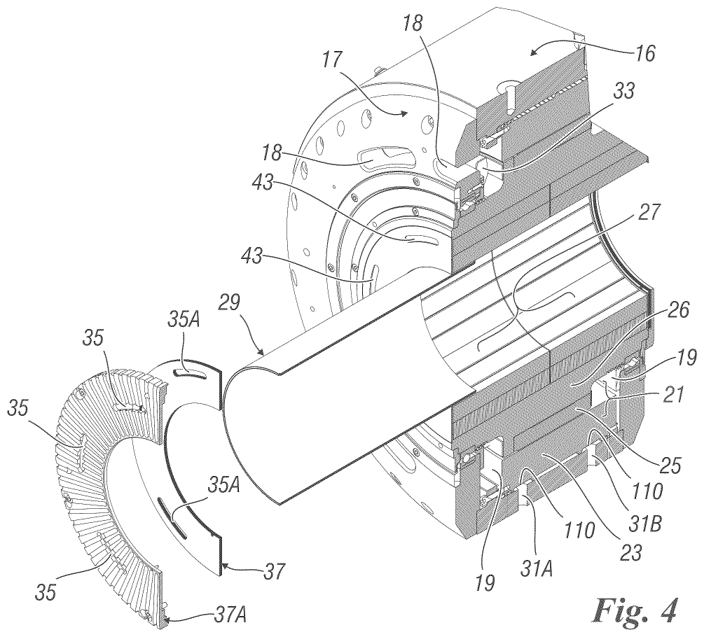

FIG. 4 shows a partially exploded perspective view of the section of FIG. 2;

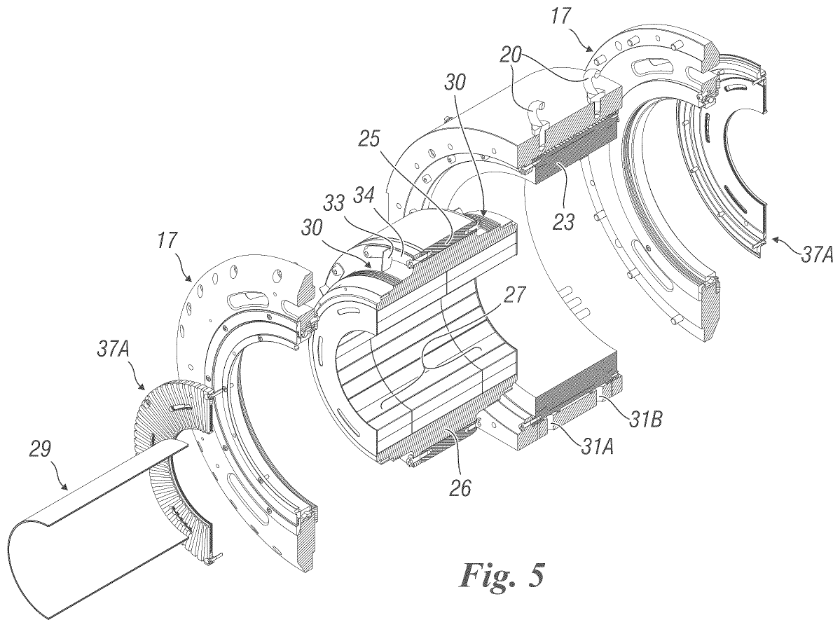

FIG. 5 shows a perspective view with further exploded parts of FIG. 2;

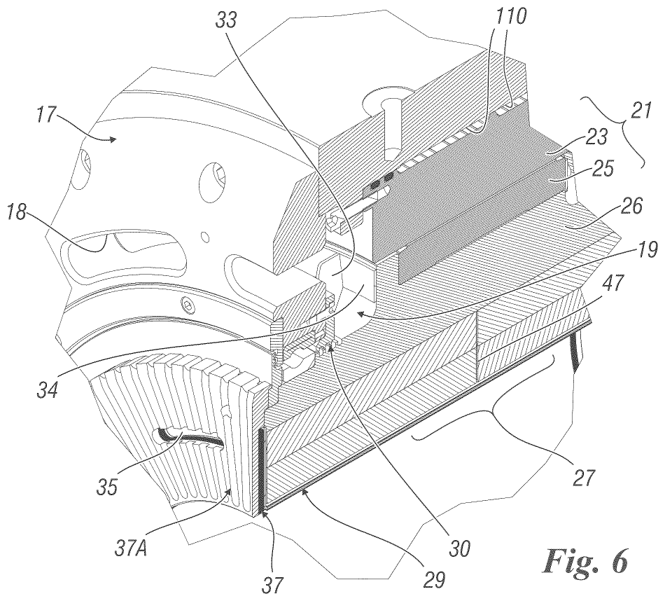

FIG. 6 shows an enlarged view of the detail indicated with A in FIG. 3;

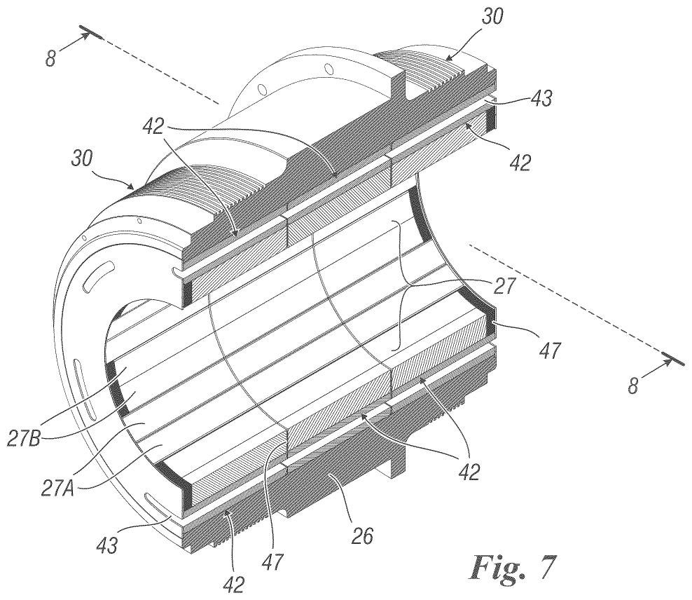

FIG. 7 shows a longitudinal cross-sectional view of a component of the furnace of FIG. 2;

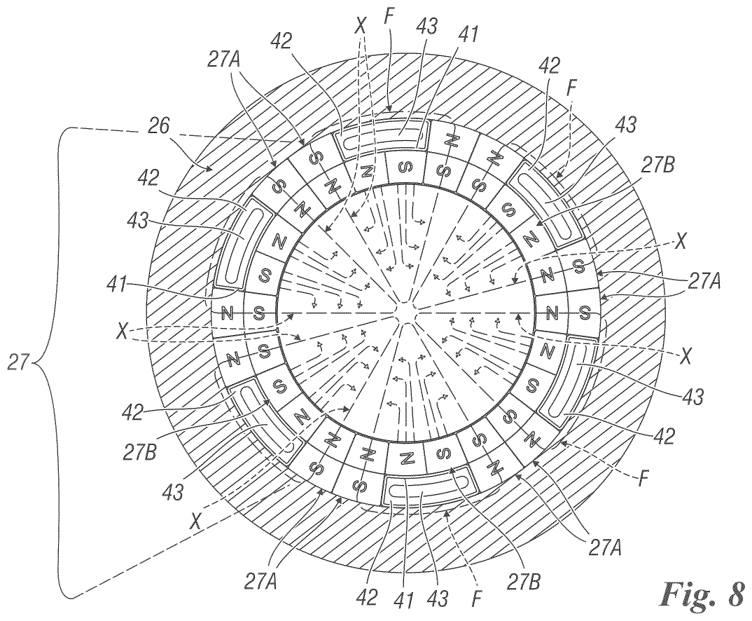

FIG. 8 shows a cross-sectional view according to line 8-8 of FIG. 7;

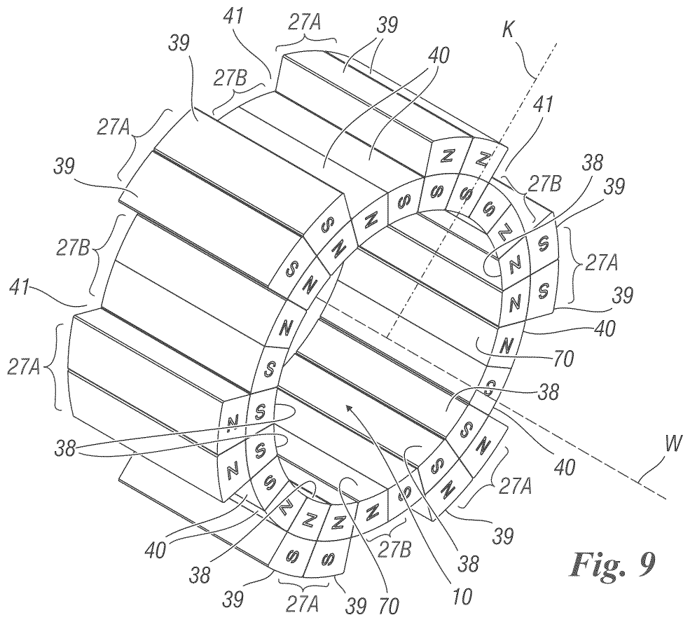

FIG. 9 shows a perspective view of a part of the component of FIG. 7; and

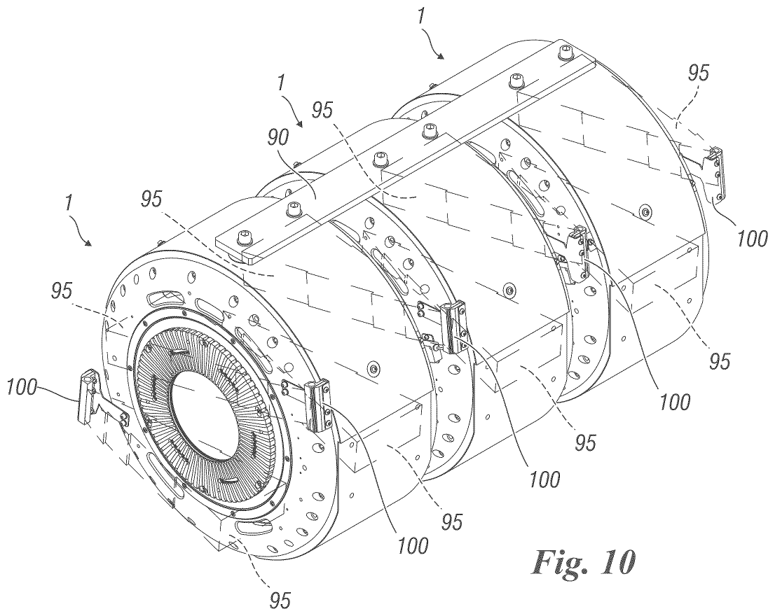

FIG. 10 shows an enlarged view of the detail indicated with E in FIG. 1.

With reference to the aforementioned figures, a furnace according to the invention is generally indicated with 1. FIG. 1 shows a system 2 comprising three magnetic induction furnaces 1 arranged adjacent and consecutively with respect to each other, fixed to each other (also see FIG. 10 which shows an elongated flat body 90 which constrains the furnaces 1) and supported by a fixed structure 3.

Obviously, the system 2 may also provide for only one furnace 1 or a plurality of induction furnaces which may also be more than three.

Without this limiting the invention, such furnaces 1 are arranged with longitudinal axis W (see FIG. 2) that is horizontal or parallel to a plane or support P on which the system 2 lies.

In a different embodiment of the system 2, one or more furnaces 1 may be arranged with longitudinal axis W that is vertical or perpendicular to the plane P. Such furnaces may be superimposed or arranged adjacent to each other. Even this solution of at least one furnace with vertical axis W is to be considered comprised in the present invention.

FIG. 10 shows, enlarged with respect to FIG. 1, only the magnetic induction furnaces 1.

Each furnace 1 is adapted to heat—by magnetic induction—a body 5 (by way of non-limiting example, an aluminium alloy billet) having a cylindrical body 6 (solid or hollow or tubular and of any cross-section). In a known manner, through common components 8 of the system 2 (which will not be described further hereinafter), such body or billet 5 is adapted to be positioned, in a part or cavity 10 of such furnace, at said cavity 10 there being provided for means adapted to generate, by magnetic induction, a radial rotating magnetic field and with variable intensity around the billet so as to create—in the latter—parasitic currents that cause the heating thereof up to a desired temperature, for example around 500° C. (in the case of aluminium alloys to be extruded) or greater (in the exemplifying cases of other non-ferrous materials such as copper, bronze, brass, silver, magnesium, titanium, or the alloy known by the name cupronickel, etc.)

The radial magnetic field generated a furnace according to the invention, contrary to the longitudinal one that is usually generated in the prior art induction furnaces, enables to have a more homogeneous and better heating of the billet with respect to what can be obtained with the current prior art solutions; in particular, it enables to obtain a heating of the billet 5 such that the outer temperature (superficial) of the latter differs very slightly with respect to the internal temperature thereof (core).

The cavity 10 of each furnace 1 is adapted to contain the billet 5 during the heating thereof without the latter being subjected to any rotary movement around the longitudinal axis thereof when in such cavity 10 there is generated the magnetic field for heating the billet by induction. Therefore, with regard to the rotation around the longitudinal axis thereof, the latter is in an absolutely fixed and stationary position (with horizontal or vertical axis) in such cavity 10 during the heating thereof being supported by known members carrying axially movable 13 (which lock the rotation thereof).

More particularly, the furnace 1 comprises a body or tubular cylindrical and tubular 16 integrally joined with the fixed structure 3 of the system 2. The tubular cylindrical and tubular 16 is closed—on two opposite sides 1A, 1B of the furnace 1—by annular outer flanges 17 having openings 18 for the dispersion of the heat which is generated in the furnace. On the carcass there are rings 20 for the movement thereof.

The tubular outer carcass 16 comprises two inner annular cavities 19 (placed in communication with the openings 18) separated by a high-efficiency electric motor for example synchronous 21 (up to 97%), power-supplied by an inverter of the system 2 (not shown in the figures).

In particular, the synchronous electric motor comprises an electric stator 23 integrally joined with the tubular carcass 16.

In such stator, there is adapted to rotate, around the longitudinal axis W, an annular electric rotor 25, provided with permanent magnets if synchronous or with reluctance, to which there is integrally joined a rotor body or support 26, cylindrical or tubular, supporting a plurality of permanent magnets 27 which delimit the cavity 10 into which the billet 5 is adapted to be introduced for the heating thereof, supported by the load-bearing members 13 of the system 2. The electric rotor 25 is arranged on a portion of the rotor body or support 26 which has part of the outer surface thereof facing towards the cavities 19 mentioned above.

In the cavity 10, facing the permanent magnets 27 and between them and the billet 5 when it is introduced into the furnace 1, there is preferably present a cylindrical tubular body 29 at least partly made of ceramic material, adapted to act as a screen for the heat irradiated by the billet 5 when subjected to the magnetic flux generated by the permanent magnets 27 carried by the rotor body or support 26 rotating around the axis W. The cylindrical body or heat screen 29 allows to create a barrier against the heat coming from the billet 5, protecting and isolating the permanent magnets 27 from the thermal irradiation of the billet; such body 29 has a further object of protecting the magnets from any impacts or foreign bodies that might penetrate into the cavity 10.

Such body or heat screen 29 can be replaced and it can be slipped off or removed from the cavity 10 when it needs to be replaced because it is damaged, dirty or because it has lost its insulating properties over time and due to use. Such body of screen can be completely made of ceramic material or refractory material or it may comprise a metal support coated internally (that is towards the cavity 10) or on both opposite cylindrical surfaces (inner and outer) made of ceramic or refractory material.

On the surface of the rotor body or support 26 there are present ribs or fins 30 also having the purpose of externally cooling such body 26 through an airflow coming from the openings 18. Such ribs or fins 30 are housed in the two cavities 19 mentioned further above.

In order to cool the body 26 (and therefore the magnets and the furnace as a whole) there are provided for fans or mechanical ventilation devices 100 on the tubular carcass 16 (see FIG. 1 and FIG. 10) which direct air blades to the lateral surface of such carcass being careful not to impact the cavity 10 with such air. The air flows or blades generated by the fans 100 are shown with dashed line in FIG. 10 and indicated with 95.

In order to cool the furnace 1, between the stator 23 and the carcass 16 there is present a circulation of a fluid (for example water or glycol) adapted to cool both the tubular carcass 16 and he stator 23 or the electric motor 21 of the furnace, said “refrigerant” fluid circulating in the furnace 1 through ducts 31A, 31B which open to the external of the carcass 16. Such fluid circulates in grooves 110 present between said stator and the tubular carcass 16 only at such stator, entering from a first duct 31A and exiting from the other 31B after flowing through the entire outer surface of the stator 23. For example, the grooves are arranged in a helical fashion around the stator to obtain such circulation.

In order to increase and move the air flow present between the rotor and the stator, a plurality of air fins 33 is also associated with the rotor. In particular, such air fins 33 are fixed to a support element 34 (for example an annular sector) fitted onto the rotor body 26 and fixed to the latter in any known manner. Obviously, the air fins 33 may be associated with the rotor body 26 in another manner or it can be obtained directly thereon.

Furthermore, at the outer flanges 17 there are present, associated with the rotor 25, of the annular bodies or annular flat strips 37 which are arranged laterally opposite (towards the side 1A and 1B of the furnace 1) to the plurality of permanent magnets 27 so as to avoid and reduce the protrusion of magnetic field lines from the opposite sides 1A and 1B of the furnace 1. Such protrusion is due to the particular conformation of the rotor body 26 or rather to the particular arrangement of the permanent magnets 27 adapted to generate a magnetic flux in the cavity 10 which penates as much as possible into said cavity so as to reach deep into the body 6 of the billet 5 present in such cavity. Furthermore, such strips 37 carry, by conduction, the heat towards the external of the furnace 1 and in particular on the finned annular bodies 37A outside the furnace and proximal to the flanges 17, so that the heat can be removed from the air blades 95 generated by the fans 100 which touch such finned bodies 37A. This allows to keep the temperature of the permanent magnets 27 at a relatively low level so as to ensure effectiveness in terms of generating the magnetic field.

The finned annular bodies and the strips 37 also have through openings 35 and 35A, respectively.

Flow diverters can be provided for at such openings 35.

The permanent magnets 27 of the rotor body 26 may be divided into two groups, which are alternated with respect to each other, depending on the arrangement thereof: a first group of permanent magnets (or “main permanent magnets” indicated in their entirety with 27A in FIGS. 7, 8 and 9) are magnetised (that is they have a relative position of the poles N and S or polar axis) with a radial arrangement along the rotor body or support 26 or they are arranged with an axis K (see FIG. 9), which reaches the North and South poles (N and S), arranged on a radius of a transversal flat section (as in FIG. 8) of the tubular cylindrical body or support 26; a second group of permanent magnets (or “auxiliary permanent magnets” indicated with 27B in FIGS. 8 and 9) instead comprises magnets which are magnetised with an axial arrangement along the rotor. The main permanent magnets 27A have poles N and S superimposed radially (along the axis K), while the auxiliary permanent magnets 27B have the poles N and S arranged adjacent to each other along the longitudinal axis of the rotor body or tubular support 26 on each circular crown in which such plurality of permanent magnets (each provided with their poles N and S) is partitioned by a plane orthogonal to the longitudinal axis W (as in FIG. 8).

In other words, in the case of the auxiliary permanent magnets 27B, the fact that they have an “axial arrangement” indicates that they are magnetised, or they have the poles N and S or the polar axes arranged circumferentially around the cavity 10 of the furnace. In other words, the poles N and S are arranged along a circumference around such cavity (the polar axes are therefore orthogonal to the radii of such circumference). They are intervalled by the main permanent magnets 27A which have the inner end part (or first end 38) facing towards the internal of the cavity 10 and preferably conformed, like a curved surface (or tile-shaped) so as to be consecutive to the auxiliary permanent magnets 27B (curved or tile-shaped) having corresponding first internal ends 70, arranged circumferentially around the cavity 10. In this manner, the main permanent magnets 27A and the auxiliary permanent magnets 27B define or at least delimit the cavity (cylindrical) 10.

Obviously, the aforementioned shape of the permanent magnets is not compulsory, given that the latter can also be parallelepiped-shaped.

The main permanent magnets 27A define poles of the rotor body 26 and they can be equal to or greater than two.

It should be observed that the main permanent magnets 27A, of the first group of magnets, have a “segment-shaped” cross-section or circular section (see FIGS. 8 and 9). Such main permanent magnets 27A may be made as a single piece or as a plurality of magnetic elements arranged adjacent to each other: for example, FIGS. 8 and 9 show the main magnets obtained by two magnetic “segments” arranged adjacent to each other by pairs along the cavity 10. This so as to facilitate the assembly thereof and improve the efficiency of the radial force lines of the magnetic field generated by such main magnets 27A.

Obviously, each segment may also not have curved surfaces, but it may have a polygonal cross-section such as a trapezium, square-shaped or rectangular. However, also in this case it will be indicated as “segment”in the present document.

The main permanent magnets are spaced with an (external) end thereof (surface) (or a second end) 39 from the corresponding external ends (second ends 40) of the auxiliary permanent magnets 27B. Each second end 39 of the main permanent magnets ends at the rotor body or support 26 and rests thereon; the second end 40 of the second permanent magnets, instead, is spaced from such rotor body 26 and therewith such second end forms a cavity 41 into which there is inserted a compensator element 42 made of thermally conductive material, made of non-magnetic material (for example aluminium) which fills said cavity totally. Each compensator element 42 has a longitudinal groove 43 (that is arranged parallel to the longitudinal axis W of the rotor body or support 26 and of the furnace 1) which acts as a groove, with a smooth or finned inner surface, for a further cooling of the plurality of permanent magnets 27, said groove opening at the terminal ends thereof at the opposite sides 1A and 1B of the furnace and at the openings 35 of the finned bodies 37A. As mentioned, the flanges 17 and the finned bodies 37A allow the heat generated in the billet 5 when it is inside the furnace 1 and which heats the magnets 27, to be removed from the air generated from the fans 100 and which touches such flanges and finned bodies. Any deflectors present at the openings 35 can improve the through-flow of the air and into the grooves 43.

The cavity 10 may be delimited by only one plurality of magnets 27 arranged on only one circumference delimiting the cavity. Or, as shown in the figures, various pluralities of permanent magnets 27 (for example three, in FIGS. 3, 4, 5 and 7), arranged adjacent to each other and magnetically phased with respect to each other, are arranged in an annular fashion (defining three circumferences arranged adjacent to each other and delimiting the cavity 10) in the rotor body or tubular support 26. This allows to facilitate the assembly of the “magnetic portion” (defined by said plurality of permanent magnets) of the furnace 1. In order to further facilitate such assembly, between each plurality of magnets 27 and the adjacent one/ones there is arranged an annular separator 47 lying on a plane orthogonal to the axis W of the rotor.

Furthermore, thanks to the magnetic phasing (that is the alternation of magnetic polarities of each plurality of magnets as shown in FIG. 8), which creates a continuity of the magnetic polarities along the longitudinal axis of the furnace, of the cavity 10, all the various pluralities of permanent magnets behave as if they were a single piece (along such longitudinal axis).

Thanks to the particular arrangement of the polarities of the magnets (see FIG. 8) there is obtained, in the cavity 10, a magnetic flux which enters deeper into the billet arranged in the furnace with respect to the prior art solutions which use magnetic fluxes for heating the billets, generated by rotary permanent magnets. As a matter of fact, as schematically shown in FIG. 8, the magnetic field of the main permanent magnets 27A (defined by the flow lines X in FIG. 8) is capable of penetrating into the inner parts of the body 6 of the billet 5 arranged in te furnace.

Given that the auxiliary magnets 27B have magnetic poles adjacent to the magnetic poles identical to those of the main permanent magnet 27A, and given that the main magnetic poles are polarised at 90°with respect to the auxiliary ones, there is obtained an “extension” and intensification of the force lines of the magnetic field generated by the main permanent magnets 27A towards the internal of the billet 5 (see FIG. 8). The magnetic field (flow lines X) generated by the main permanent magnets 27A penetrates deep into the cavity 10 reaching the interior, and deep, parts or the body 6 of the billet 5 so as to further heat the latter with respect to the prior art solutions, even therein. At the same time, there is obtained a (significant) decrease in the magnetic field which penetrates into the rotor body or tubular support 26.

Another advantage of this solution lies in the fact that the rotor body or tubular support 26 may have a smaller thickness with respect to similar solutions having only magnets all of which are arranged like the main permanent magnets 27A given that the effect on the magnetic field generated by the main permanent magnets caused by the auxiliary permanent magnets 27B, displaces such magnetic field towards the internal of the cavity 10 more than it interests the body or tubular support 26 (see dashes in FIG. 8). This allows to obtain a ratio between the magnetic flux generated towards the internal of the furnace 1 with respect to the one that closes towards the external (that is towards the support 26 of the magnets 27) by about 70%-75% to 30%-25% (that is—towards the internal—there is generated a magnetic flux equal to more than twice the one that closes in the tubular support 26). Furthermore, it should be observed that the magnetic flux generated by the magnets 27 towards the external of the furnace closes in the tubular support 26 (see flow lines F in FIG. 8) and it does not interfere with the one present in the electric rotor 25 of the electric motor 1 whose magnetic field, in turn, closes therein.

This also allows to reduce the thickness and therefore the diameter, the mass, the inertia and the costs of such rotor body or tubular support 26.

Besides this, the presence of the strips 37 allows, together with the presence of surface ribs 30 and the fins 33, an optimal cooling of the rotor during the rotation thereof around the axis W when heating the billet 5. In addition, it should be observed that such strips 37 create an optimal axial barrier (that is towards the sides 1A and 1B of the furnace 1) to the rotary magnetic field generated by the permanent magnets 27 when using the furnace, the rotation being obtained through the electric motor, for example synchronous, comprising the stator 23 and the rotor 25. Therefore, the invention attains advantages both in terms of heating the billet 5 and in particular in terms of the quality of such heating (thermalisation or temperature uniformity in each cross-section of such billet), in the time required to obtain an optimal heating of the billet (which reduces with respect to the times of the prior art solutions resulting in a higher hourly production rate) and in terms of safety for the people and goods near the furnace 1 in the system 2. All this being due to the fact that all the emitted magnetic fields remain confined in the furnace.

In an alternative embodiment, the electric motor 21 may be of the any known asynchronous type: for example, it may provide for a squirrel-cage rotor or it may be of the reluctance type.

Obviously, in the light of the description above, the person skilled in the art may find solutions equivalent to those described in the present document so as to obtain a magnetic induction furnace used for heating metal billets according to the characteristics defined by the claims that follow.

1-14. (canceled)

15. Magnetic induction furnace configured to heat a solid or tubular metal billet made of non-ferrous material, said furnace comprising:
a fixed body containing an electric motor having a fixed stator and an annular rotor movable in rotation around a longitudinal axis thereof in said stator, said rotor being integrally joined with a rotor body supporting a plurality of permanent magnets arranged so as to define a cavity having a longitudinal axis coincident with a rotation axis of the rotor and configured to contain the billet to be heated, by magnetic induction, by rotating the rotor and the joined rotor body, a rotation around a longitudinal axis thereof of said billet being prevented when the billet is disposed in the cavity, the plurality of permanent magnets comprising main permanent magnets magnetized radially in the rotor body and auxiliary permanent magnets magnetized axially around the cavity of the rotor, said main and auxiliary permanent magnets alternating in said rotor body around the cavity of the furnace; and
wherein the main permanent magnets are polarized at 90° with respect to the polarization of the auxiliary permanent magnets, and wherein each of the main permanent magnets has an inner end part facing towards the cavity of the furnace and an outer end part resting on said rotor body, each of the inner end parts of the main permanent magnets is disposed adjacent to, and has the same polarity as, an inner end part of one of the auxiliary permanent magnets, and wherein the auxiliary permanent magnets have outer end parts spaced from the rotor body to form cavities in-between, respectively.

16. Magnetic induction furnace according to claim 15, wherein each main permanent magnet comprises a single piece or comprises a plurality of coupled magnets.

17. Magnetic induction furnace according to claim 15, wherein said cavities between the auxiliary permanent magnets and the rotor body contain compensator elements made of thermally conductive material.

18. Magnetic induction furnace according to claim 17, wherein the compensator elements have longitudinal grooves, respectively, the longitudinal grooves of the compensator elements of the rotor body opening outside the rotor body at opposite sides of the furnace at through-openings in outer finned annular bodies of the furnace.

19. Magnetic induction furnace according to claim 18, wherein each longitudinal groove is finned internally.

20. Magnetic induction furnace according to claim 15, comprising strip assemblies disposed on opposite sides of the furnace to help prevent axial portions of the magnetic fields generated by the permanent magnets from projecting outwardly from the sides of the furnace, the strip assemblies having outer finned annular bodies for conducting heat generated inside the furnace to outside the furnace.

21. Magnetic induction furnace according to claim 20, wherein the outer annular finned bodies have openings extending therethrough, and wherein the cavities between the auxiliary permanent magnets and the rotor body contain compensator elements made of thermally conductive material, the compensator elements having longitudinal grooves extending therethrough, the longitudinal grooves being aligned with and extending between the openings in the outer annular finned bodies, respectively.

22. Magnetic induction furnace according to claim 21, comprising fans arranged external to the fixed body of the furnace and configured to generate an air flow which touches the outer annular finned bodies, but not the cavity of the furnace, said air flow penetrating into the openings of the outer annular finned bodies of the strip assemblies and into the longitudinal grooves of the compensator elements.

23. Magnetic induction furnace according to claim 22, comprising, at the openings of the outer annular finned bodies, flow diverters configured to direct the air flow into the longitudinal grooves.

24. Magnetic induction furnace according to claim 15, comprising, at the first end parts of the main and auxiliary permanent magnets delimiting the inner cavity of the furnace, a tubular cylindrical body at least partly made of ceramic material configured as a screen for the heat emitted by the billet when the billet is subjected to the magnetic flux generated by the permanent magnets of the rotor body rotating around the longitudinal axis, said tubular cylindrical body being removable and replaceable.

25. Magnetic induction furnace according to claim 15, wherein the rotor is integrally joined with a circumferential portion of the rotor body, said rotor body having, externally, ribs for cooling cavities disposed between the rotor body and the fixed body of the furnace, the stator and the rotor.

26. Magnetic induction furnace according to claim 25, wherein said rotor body has, externally, a plurality of fins in the cavities between the rotor body and the fixed body of the furnace, the stator and the rotor, said fins being configured to increase and move air flow present in such cavities towards openings in flanges arranged laterally on the fixed body of the furnace.

27. Magnetic induction furnace according to claim 15, wherein the cavity of the furnace is defined by pluralities of permanent magnets, each plurality of permanent magnets delimiting a part of said cavity, said pluralities of permanent magnets being arranged longitudinally adjacent and magnetically phased with respect to each other in said furnace, and wherein annular spacers are disposed between longitudinally adjacent pairs of the pluralities of the permanent magnets, the annular spacers being arranged on planes orthogonal to the longitudinal axis of the rotor.

28. Magnetic induction furnace according to claim 15, wherein the fixed body has ducts that open exterior to the fixed body and through which refrigerant may pass to be circulated between the fixed body and the stator.
